(19) United States
(12) Patent Application Publication
(10) Pub. No.: US 2003/0185220 A1
(43) Pub. Date: Oct. 2, 2003

(54) Dynamically loading parsing capabilities

(76) Inventor: Moshe Valenci, Givat-Zeev (IL)

Correspondence Address: Timothy N. Trop, TROP, PRUNER & HU, P.C., STE 100, 8554 KATY FWY, HOUSTON, TX, 77024-1841, US

(21) Appl. No.: 10/107,626

(22) Filed: Mar. 27, 2002

(51) Int. Cl. H04L 12/28; H04L 12/413

(52) U.S. Cl. 370/398; 370/445

(57) ABSTRACT

Parsing capabilities may be provided to define a parser within network hardware. By selectively loading one or more desired parsing capabilities, a parser may change its behavior. In one embodiment, a loadable set of rules associated with a particular packet type may be used to provide a dynamic parser (e.g., defined in a state machine). For a host, a data packet (e.g., an Ethernet packet) may be received in an adapter of an Ethernet device. Before transferring the data packet from the Ethernet device to the host, one or more action-based parsing rules may be dynamically loaded in the adapter. Instead of parsing the data packet based on a static set of pre-loaded rules, the dynamic parser may advantageously use the dynamically loaded action-based parsing rules to identify the data packet based on the packet type, for example.

### BACKGROUND

This invention relates generally to parsing data, and more particularly to dynamically loading parsing capabilities to recognize data, such as a packet while communicating within networked systems or devices.

Several protocols are available for data communications between networked systems or devices. Ethernet is a common protocol for a packet-based network, such as local area networks (LANs). Like other packet-based network protocols, Ethernet enables communication of data in packets (e.g., a data packet, such as an Ethernet packet) over a network. These packets include a source and a destination address, the data being transmitted, and a series of data integrity and security bits. For example, a typical Ethernet packet used for transferring data across a network generally includes a preamble which may include a start frame indication, a destination address to identify the receiving node for the Ethernet packet, a source address to identify the transmitting node directly on the transmitted packet, and a set of fields to indicate packet characteristics, such as the packet type. Typically, a computer system may communicate over a network using an interface that includes an Ethernet adapter to enable transfer of Ethernet packets from one Ethernet device to another Ethernet device coupled to the network.

Among other layers, a protocol stack for the Ethernet includes a media access control (MAC) layer. A conventional Ethernet media access controller corresponding to the MAC layer is responsible for controlling the flow of data over a network, including encapsulating received data from an upper layer based on processing control information (e.g., rules). When an Ethernet packet is received at the Ethernet adapter, a MAC-based controller may parse the Ethernet packet using static rules (e.g., microcode) for a subsequent transfer to a host. A typical MAC-based controller includes a parser with a set of associated rules to process the Ethernet packets.

Although all the rules may not be useful to some applications or users, the undesired rules cannot be dropped easily since the parser may be hardcoded, depriving a need-based selection of the rules and wasting precious hardware real estate especially silicon die area. When the “microcode” is changed, manufacturing may have to be stalled before appropriate standards are stabilized, significantly increasing validation overhead. That is, when the parsing capabilities of an Ethernet adapter need a change, a parser may need to be validated again. Moreover, once processing control information (e.g., rules defining parsing capabilities) is passed to the parser, this information remains “static” for a particular Ethernet packet or a predetermined number of Ethernet packets because it may be difficult to modify the parsing operations performed by the MAC-based controller during a communication.

Thus, there is a need to selectively change or modify parsing capabilities for packets.

### BRIEF DESCRIPTION OF THE DRAWINGS

FIG. 1 is a schematic depiction of a system consistent with one embodiment of the present invention;

FIG. 2 is a schematic depiction of an Ethernet device coupled to a host system in accordance with one embodiment of the present invention; and

FIG. 3 is a schematic depiction of a media access controller in accordance with an embodiment of the present invention;

FIG. 4 shows a state machine defining a dynamic parser according to one embodiment of the present invention;

FIG. 5A is a flow chart showing how data in the Ethernet device of FIG. 2 may be routed in accordance with one embodiment of the present invention;

FIG. 5B is a flow chart showing how a data packet may be parsed by one embodiment of the dynamic parser of FIG. 2 in accordance with one embodiment of the present invention;

FIG. 5C is a flow chart showing how a data packet may be parsed by another embodiment of the dynamic parser of FIG. 2 in accordance with one embodiment of the present invention;

FIG. 6 is a schematic depiction of a computer system capable of dynamically loading parsing capabilities for an Ethernet packet according to one embodiment of the present invention; and

FIG. 7 is a schematic depiction of one embodiment of the Ethernet device of FIG. 2 capable of dynamically loading parsing capabilities for an Ethernet packet according to one embodiment of the present invention.

### DETAILED DESCRIPTION

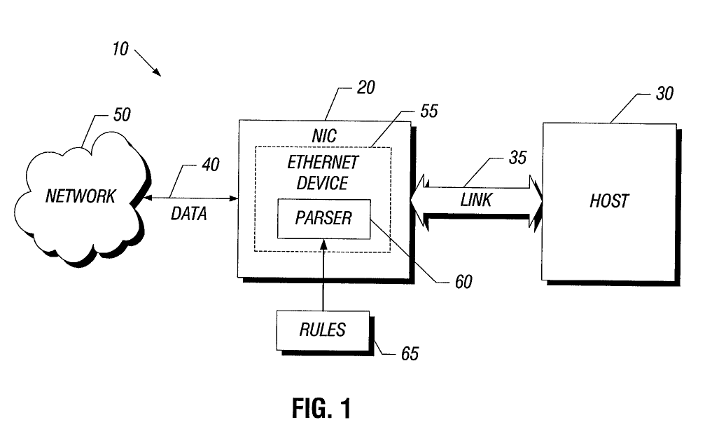

A system 10 as shown in FIG. 1 includes an interface, such as a network interface card (NIC) 20 coupled to a host 30 via a link 35 for communicating data on a communication medium 40 (e.g., a network wire or coaxial cable), over a network 50 capable of processing packets of the data. The NIC 20 includes an Ethernet device 55 comprising a parser 60 which may dynamically load processing control information (e.g., rules that define parsing capabilities) from a source 65 storing rules. Using the parser 60, media access control layer processing may be provided within the Ethernet device 55 to controllably manipulate packets in network hardware, allowing packet processing information to be selectively modified while managing the packets being transmitted and received through the network 50.

According to one embodiment, the Ethernet device 55 may be a network controller that enables communication of Ethernet packets for the host 30 over the network 50. In some embodiments, the source 65 may be a database or a non-volatile storage device, such as an erasable programmable read-only memory (EPROM) which is programmable and can be erased and reused.

A typical data packet used for transferring data across the network 50 may include at least one of a length and a type field to indicate either the length or type, or both characteristics, of the data field that follows. Based on information provided in these fields, a data packet may be appropriately classified. In one case, if a length is provided, the data packet is classified as an Institute of Electrical, Electronic Engineers (IEEE) standard 802.3 based packet, and if the type field is provided, the packet is classified as an Ethernet packet. The IEEE standard 802.3 is set forth in a specification entitled “Information Technology—LAN/MAN—Part 3: Carrier Sense Multiple Access with Collision Detection (CSMA/CD) Access Method and Physical Layer Specifications, ISO/IEC 8803-2000 and ANSI IEEE std. 802.3-2000.”

Regardless of the data rates, the Ethernet device 55 may process Ethernet packets for the entire class of the CSMA/CD protocols, such as indicated in a family of known computer industry standards. For example, including but is not limited to, 1-megabit Ethernet, 10-megabit Ethernet, 100-Megabit Ethernet, known as “Fast Ethernet,” 1000-Megabit Ethernet or 1-Gigabit Ethernet, known as “Gigabit Ethernet” and any other network protocols at any other data rates that may be useful in packet-based networks.

In operation, using the Ethernet device 55, the host 30 may communicate with another Ethernet device by exchanging packets, or frames, of information over the network 50 based on a network protocol. As an example, the network protocol may be a Transmission Control Protocol/Internet Protocol (TCP/IP), and as a result, the another Ethernet device and the host 30 may implement protocol stacks, such as TCP/IP stacks.

For the Ethernet device 55 (e.g., a client or a node on the network 50), in one case the TCP/IP stack may be divided into five hierarchical layers: an application layer, a transport layer, a network layer, a data link layer and a physical layer. For example, in some embodiments, an open systems interconnection (OSI) layered model developed by the International Organization for Standards (ISO) as set forth in a specification entitled “Information technology—Telecommunications and information exchange between systems—Use of OSI applications over the Internet Transmission Control Protocol (TCP) ISO/IEC 14766:1997” may be used. This specification generally describes the exchange of information between layers is particularly useful for separating the functions of each layer, and thereby facilitating the modification or update of a given layer without detrimentally impacting on the functions of neighboring layers. At the lowest layer, the OSI model includes the physical layer that is responsible for encoding and decoding data into signals that are transmitted across the communication medium 40.

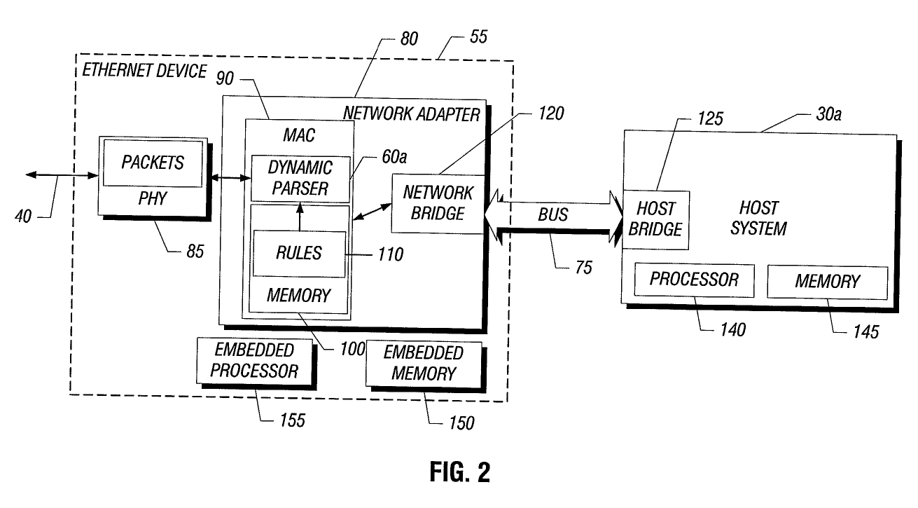

Referring to FIG. 2, the Ethernet device 55 is coupled to a host system 30a via a bus 75 such as a peripheral component interconnect (PCI) bus, according to one embodiment of the present invention. The Ethernet device 55 further includes a network adapter 80 to receive the network data on the communication medium 40. The network data received over the communication medium 40 is received in a physical layer (PHY) 85. The network data may include packets in one embodiment.

To process the packets, the network adapter 80 includes a media access control (MAC) 90. The MAC 90 further includes a dynamic parser 60a and a memory 100, storing a set of rules 110. The rules 110 may be used by the dynamic parser 60a in one embodiment. Using a pair of bridges, the bus 75 may operably couple the Ethernet device 55 to the host system 30a. More specifically, the network adapter 80 comprises a network bridge 120 to interface with a host bridge 125 of the host system 30a. While the network bridge 120 enables the Ethernet device 55 to communicate with the bus 75, the host bridge 125 enables the host system 30a to communicate with the bus 75, in accordance with one embodiment of the present invention.

By deploying any one of a variety of available architectures, the host system 30a may include a host processor 140 and a host memory 145 in one embodiment. Examples of the host system 30a include a processor-based system, such as a desktop computer, a laptop computer, a server, or any of a variety of other computers or processor-based devices. In addition, the Ethernet device 55 may be part of an Ethernet adapter that also includes an embedded memory 150 and an embedded processor 155. Both the embedded memory 150 and the embedded processor 155 may be operably coupled to the network bridge 120, in one embodiment of the present invention.

While protocol data units (PDUs) may be stored in the host memory 145, protocol headers, such as Ethernet headers, for the Transmission Control Protocol/Internet Protocol (TCP/IP) may be formed in the embedded memory 150. A typical Ethernet packet may include an IP header that indicates such information as the source and destination IP addresses for the packet. The Ethernet packet may include a security header that indicates a security protocol (e.g., an IPSec protocol) and attributes of the packet. Also, the Ethernet packet may include a transport protocol header (a TCP protocol header, as an example) that is specific to the transport protocol being used. As an example, a TCP protocol header might indicate a TCP destination port and a TCP source port that uniquely identify the applications that cause the Ethernet device 55 associated with the host system 30a to transmit and receive the packets. The Ethernet packet may also include a data portion, the contents of which are furnished by the source application, and a trailer that is used for encryption purposes.

As an example, a TCP protocol header may include a field that indicates the TCP source port address and a field that indicates the TCP destination port address. Another field of the TCP protocol header may indicate a sequence number that is used to concatenate received packets of an associated flow. Packets that have the same IP addresses, transport layer port addresses and security attributes are part of the same flow, and a sequence number indicates the order of a particular packet in that flow.

As an example, software that is associated with the transport and network layers, when executed by a processor 155 of the Ethernet device 55, typically causes the Ethernet device 55 to parse the information that is indicated by the protocol header to facilitate additional processing of the packet. However, the execution of the software parsing of the Ethernet packets may introduce delays that impede the communication of the Ethernet packets from the Ethernet device 55 for the host system 30a.

On the other hand, hardware-based MAC implementations often use an internal parser embedded into network hardware to identify packet types in order to apply actions. Examples of these actions may include parsing Internet Protocol security (IPSec) packets and matching parameters in order to imply inline decryption, parsing wake-up packets, parsing manageability packets, and splitting parsed packet headers in order to achieve zero copy performance. However, such hardware-based MAC implementations may be inefficient. One reason for inefficiency in such hardware parsers includes pre-loading unnecessary rules associated with packets that a user may never use.

More specifically, when a packet format is to be defined while the network hardware (e.g., integrated circuit (IC) chip) planning may not be delayed, the hardware-based MAC implementations are significantly constrained. That is, once parsing rules have been configured, and the network hardware has been manufactured, redefining the parsing rules may not be feasible. In addition, the preference for functionality may change among the original equipment manufactures (OEMs).

Another problem involves defining inline parsing rules for the IPSec capable Ethernet adapters where a protocol change may be difficult to address, for example, when transitioning from one type of encapsulation to another type of encapsulation, even if a generic cryptographic engine is deployed. Defining inline parsing rules for “Header Splitting” features may also be difficult because predicting the preferred protocol types may not be generally feasible. That is, processing or defining rules for a “Header Splitting” feature in the hardware-based MAC implementations may be difficult. In general, the “Header Splitting” feature makes it possible to define a split between packet data, and packet headers. One reason to use splitting is to have user data on a page boundary, so it can be transferred to a particular user space without copying (e.g., Zero Copy). However, the user data may exist in various offsets. Depending on the protocol types which are being used, extraction of the user data from a TCP packet may become difficult while using static parsing/action rules.

To this end, in one embodiment, the MAC 90 may comprise a combination of functional components, including but not limited to, a rule-based parser, a set of dynamically loadable parsing rules, an action-based component, and a set of dynamically loadable action rules. The rule-based parser behaves according on the loadable sets of rules. The parsing and action rules may be dynamically loaded from an external interface (e.g., software, EPROM). The action-based component may perform various desired actions on a processed packet based on a parsed state of the packet. The action rules determine how actions may be applied to the packet. In some embodiments, both the parsing and action rules may be dynamically loaded to provide parameters to the action-based component.

Without limiting the scope of the present invention, an ability may be provided in the MAC 90 to dynamically load parsing and/or action rules rather than using “microcode” for manipulating packets. Some examples of addressing one or more above indicated problems include handling inbound IPSec traffic or dynamically adding rules to add user datagram protocol (UDP) encapsulation capabilities. Likewise, dropping of packets may be carried out based on a predefined policy and out-of-band information may be added for the parsed packet, as examples. Stripping of particular data from the packet, such as a virtual local area network (VLAN) tagging, may also be done in one embodiment. Splitting the data region of the packet on page aligned buffers may be accomplished as well in some embodiments.

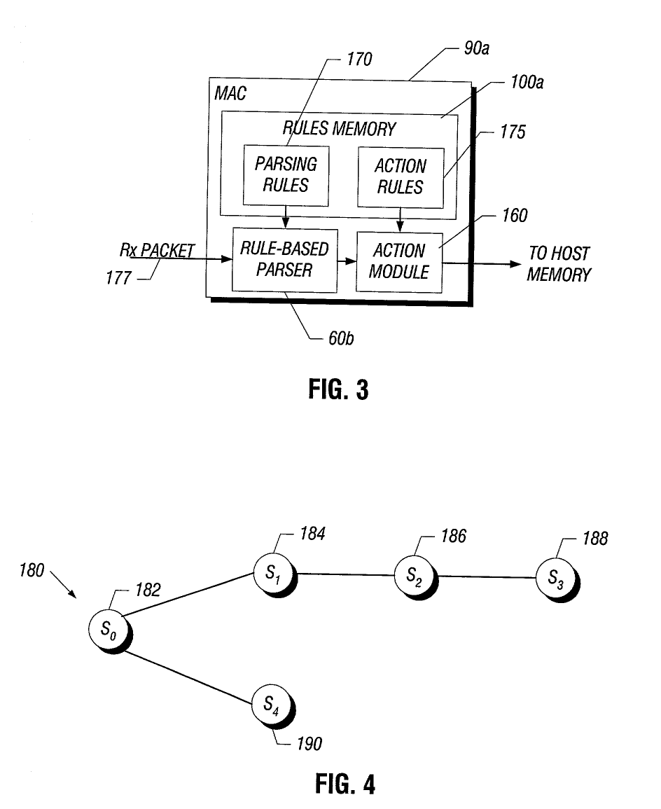

Consistent with one embodiment of the present invention, a media access control (MAC) 90a is shown in FIG. 3. The MAC 90a includes memory for rules 100a and the rule-based parser 60b and an action module 160. The memory for rules 100a includes a set of parsing rules and a set of action rules. The parsing rules may be dynamically loaded into parsing rules memory 170. In a similar fashion, the action rules may also be dynamically loaded into the action rules memory 175. For appropriate classification of packets, the rule-based parser 60b may receive a packet on a receive path 177. Then, based on the dynamically loaded parser rules, the rule-based parser 60b attaches a state to the received packet. The action module 160 processes the received packet according to the given state by using the action rules. Then, in some embodiments, the received and processed packet may be forwarded to the host system 30a, more particularly, to the host memory 145 shown in FIG. 2.

A state machine 180 shown in FIG. 4 may be represented by a parser table, which can be used by the rule-based parser 60b of FIG. 3 according to one embodiment of the present invention. The state machine 180 includes a plurality of states including a “S0” state 182, a “S1” state 184, a “S2” state 186, a “S3” state 188, and a “S4” state 190. As shown in Table 1, the parser table includes a table line or row with each table line having multiple table entries or fields, for example, a packet offset field, a packet value field, and “PRE,” “POST” states where a last bit indicates if it is a final state.

TABLE 1

| Offset | Value | PRE State | POST State |
|---|---|---|---|
| 12 | 0x0800 | S₀ | S₁ |
| 12 | 0x8137 | S₀ | S₄ |
| 14 | 0x45 | S₁ | S₂ |
| 23 | 0x06 | S₂ | S₃ |
| . . . | . . . | . . . | . . . |

Some examples of the packet offset include 12, 12, 14, 23 bits of offset. Similarly, examples of the packet value include hexadecimal values, such as 0×0800, 0×8137, 0×45, and 0×06. While a starting state for a transition in the state machine 180 may be treated as a “PRE” state, the ending state of the transition may be indicated as a “POST” state. For instance, one transition from the “S0” state 182 to the “S2” state 186 may indicate the “S0” state 182 as the “PRE” state and the “S2” state 186 as the “POST” state.

Of course, when the state machine 180 is loaded as parsing rules into the parsing rules memory 170, any number of states may be advantageously provided depending upon a specific application. For parsing incoming packets, the memory for rules 100a associated with the rule-based parser 60b of FIG. 3 describes the state machine 180. In one specific case, the state machine 180 is used to classify and then split simple TCP data from the headers (e.g., classification may be provided by the rule-based parser 60b, and splitting may be provided by the action module 160). In one embodiment, the table lines in the parsing table are ordered according to the offset field to parse the incoming packet using only one pass. Of course, “on-the-fly” parsing may be provided in some embodiments where parsing may begin before the packet was fully received (e.g., as the packet gets into the first-in-first-out (FIFO) or any other component serially).

When the MAC 90a of FIG. 3 is configured to serially parse the data flow, the packet offset field may be examined for each packet by going through each table line. After a packet is parsed, the action rules in the memory for rules 100a may be informed accordingly. A memory layout for the memory for rules 100a (e.g., in a table format) may define one way to break the packet into one or more page-aligned buffers in some embodiments. The memory layout may comprise a final state and a corresponding break offset in some embodiments of the present invention. Based on the final state, the network hardware, i.e., the Ethernet device 55, may split the data from the headers for the packet.

As described above, a parsing state may be associated with a packet being parsed. Based on the parsing state, the memory layout may indicate at which offset the packet may be split. In one case, for the final state being the “S3” state 188, the break offset may be 52 bits where a TCP data offset is provided to break user data included in the packet. A “zero” break offset may indicate no splitting is desired. In order to implement a split, for each table line or row of the parsing table, the state associated with the packet is checked against the final state in that table line or row. When the state is determined to be the final state, a transfer function is initiated using the break offset indicated in that table line or row. Using the state machine 180 and a memory layout, various parsing rules for addressing multiple protocol types may be defined in one embodiment. For example, a memory size for the memory for rules 100a may be derived as 24 bytes for a parsing table, i.e., (2 bytes (word)×4 (columns)×3 (rows)) and 8 bytes for an action based table, i.e., (2 bytes (word)×2 (columns)×2 (rows)).

When multiple breaks per packet are desired, in one embodiment, the number of columns may be increased accordingly. In this case, the increase in the size for the memory for rules 100a may be moderate, however, while parsing other protocol types, a linear increase of the memory size may be desired. In some embodiments, should there be any memory space limitations, the parsing rules may be partially performed and packets may be split based on these partial rules. In such a case, a software stack may be used as a verifier to check whether the parsing was addressed correctly based on these partial rules. An improper splitting of the data may be indicated as unaligned, using available traditional operating system (OS) mechanisms for one embodiment of the present invention.

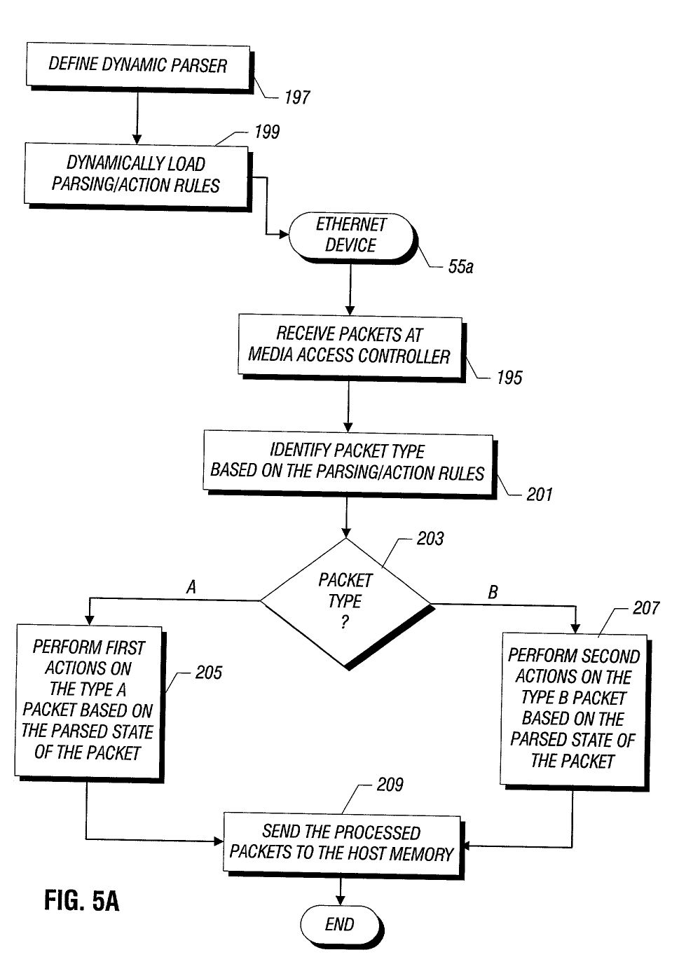

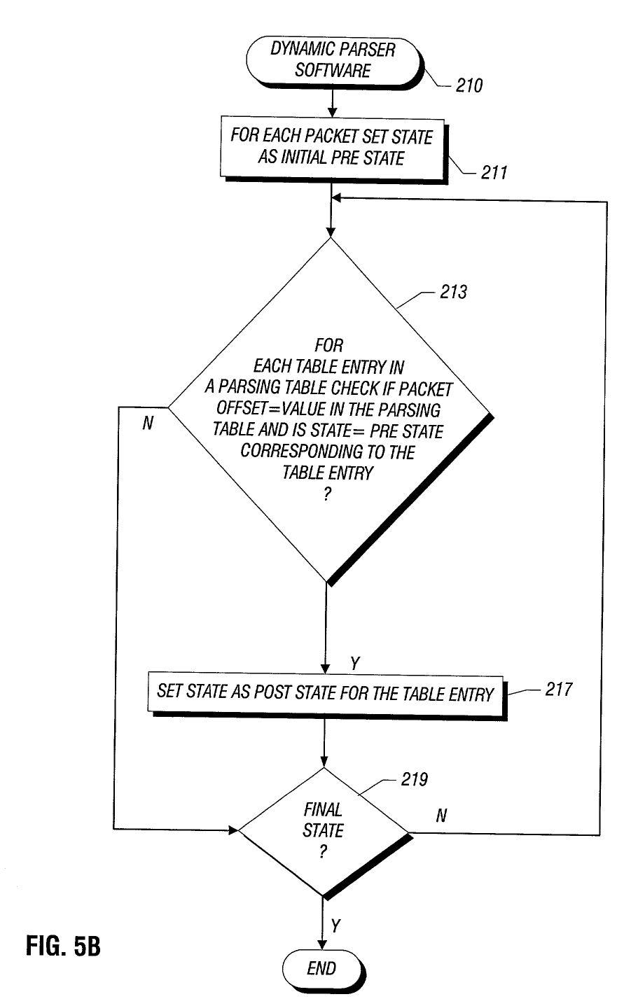

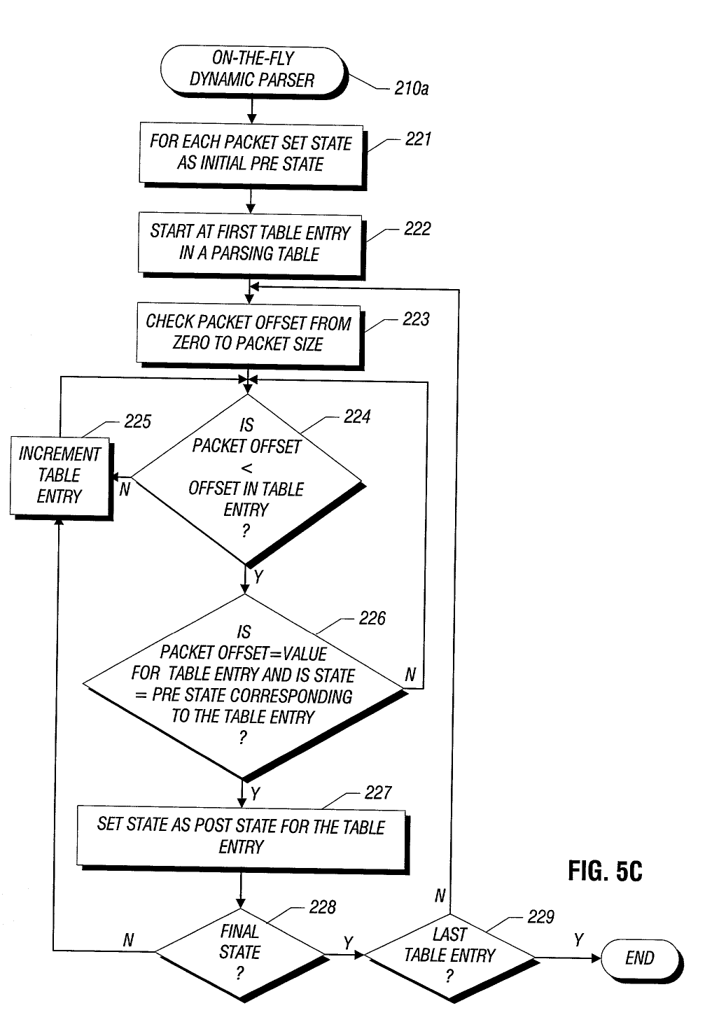

An Ethernet device 55a shown in FIG. 5A may receive packets for a media access control layer processing at block 195. The rule-based parser 60b (FIG. 3) may be selectively defined at block 197. The rule-based parser 60b may be defined in either alone or in a combination of at least one of firmware, software, and hardware. Based on the definition, one or more parsing/action rules may be either dynamically loaded at block 199, or alternatively existing parsing/action rules in the rules memory 100a may be used. Using the parser/action rules, packet types of the received packets may be identified at block 201. A check at diamond 203 may determine the packet type of a packet under processing by associating a parsed state therewith. If the packet type is determined to be of type A, one or more first actions may be performed on that packet based on that parsed state of the packet at block 205. Conversely, if the packet type is determined to be of type B, one or more second actions may be performed based on the parsed state of the packet at block 207. In one embodiment, the processed packet may be sent to the host memory 145 (FIG. 2) at block 209.

A packet may be of any one of types based on one or more characteristics derived from information included within the packet. For example, a particular field of the packet may characterize the packet types, i.e., the type A, or B. In some embodiments, the type A may be differentiated from the type B on the basis of the packet offsets indicated in the packet.

For each packet, dynamic parser software 210 shown in FIG. 5B may set a state as an initial “PRE” state according to the state machine 180 of FIG. 4 at block 211. In one embodiment, a parsing table including one or more table entries may represent the state machine 180. For each table entry in the parsing table, a check at diamond 213 may ascertain (1) whether the packet offset associated with the packet matches the corresponding value in the parsing table and (2) whether the state is indeed the “PRE” state corresponding to the table entry. If the offset and state do not have a corresponding value in the parsing table then the dynamic parser software 210 proceeds to the diamond 219. Otherwise, the state is set to be a “POST” state corresponding to the appropriate table entry at block 217.

A check at diamond 219 may determine whether the state is the final state within the state machine 180 of FIG. 4. If the state is determined to be the final state, the dynamic parser software 210 may finish this iteration. Alternatively, the dynamic parser software 210 may again perform the check at the diamond 213 for each table entry in the parsing table. In this way, the dynamic parser software 210 may continue to provide appropriate packet routing. That is, the dynamic parser software 210 may enable packet switching where each Ethernet packet is first examined to determine its destination and then forwarded to an appropriate destination port. As a result, only its destination port sees the Ethernet packet.

Common methods for switching include an “on-the-fly” method, a “store-and-forward” method, and a “fragment-free” method. In the “non-on-the-fly” methods, a time delay from receiving a data packet to transmitting the data packet is significantly large. However, in the “on-the-fly” method, a destination address field may be provided in a header of a data packet, significantly reducing the time delay from receiving the data packet to transmitting the data packet.

An “on-the-fly” dynamic parser 210a is shown in FIG. 5C for dynamically loading one or more actions and parsing rules in one embodiment. At block 221, for each packet, the associated state is set to an initial “PRE” state according to the state machine 180 of FIG. 4. Then, starting at a first table entry in a parsing table at block 222, the “on-the-fly” dynamic parser 210a may check the packet offset from zero to the packet size for each packet at block 223.

A check at diamond 224 determines whether the packet offset is less than the offset indicated for that packet in a particular table entry. If so, another check at diamond 226 may compare the packet offset to the value for that packet in that particular table entry. The associated state may be checked against a “PRE” state corresponding to that particular table entry. Conversely, if at the diamond 224, it is determined that in a particular table entry, the packet offset is greater than the offset for that packet, the next table entry of the parsing table is processed at block 225.

For each packet, the associated state may be set as the “POST” state corresponding to a current table entry at block 227. In one embodiment, a check at diamond 228 as to the status of the associated state may determine whether an associated state for a packet being processed is a final state of the state machine 180 (FIG. 4). If that is not the case, then the current table entry may be incremented to a next table entry in block 225. Otherwise, another check may be performed for the current table entry at diamond 229. If determined to be the last table entry, then the “on-the-fly” dynamic parser 210a may finish the current iteration. Alternatively, the “on-the-fly” dynamic parser 210a may proceed to the block 223, in one embodiment.

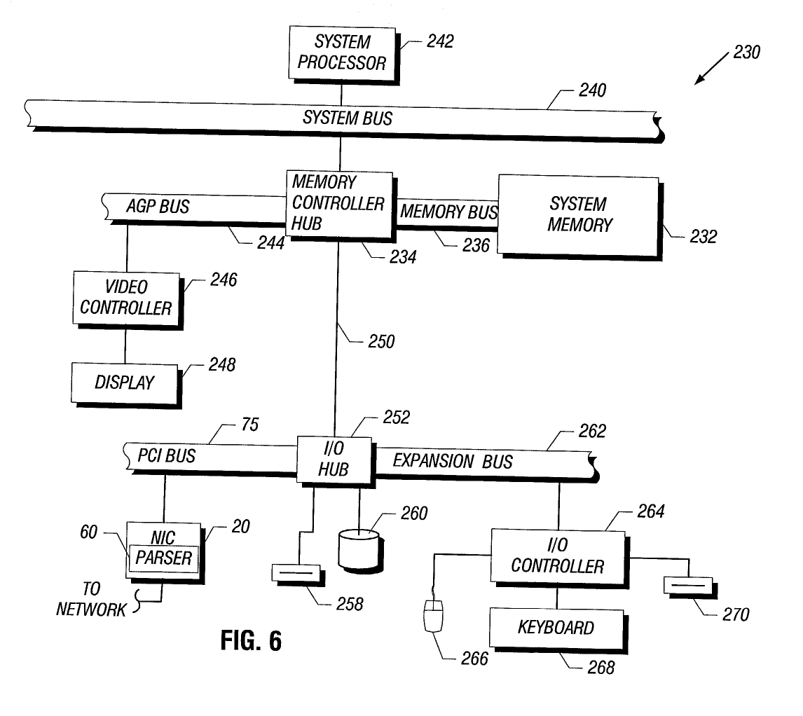

Referring to FIG. 6, in some embodiments of the present invention, a computer system 230 may include a system memory 232 coupled to a memory controller hub 234. In particular, in some embodiments of the present invention, the computer system 230 may include a processor 242 (one or more microprocessors or controllers, as examples) that is coupled to a system bus 240. The system bus 240, in turn is coupled to the memory controller hub 234 along with an accelerated graphics port (AGP) bus 244. The AGP bus 244 is described in detail in the Accelerated Graphics Port Interface Specification, Revision 1.0, published on Jul. 31, 1996, by Intel Corporation of Santa Clara, Calif.

The computer system 230 may also include a display controller 246 that is coupled to the AGP bus 244 and generates signals to drive a video display 248. The memory controller hub 234 is also coupled (via a hub interface 250) to an input/output (I/O) hub 252. The I/O hub 252 may provide interfaces to, for example, the PCI bus 75 of FIG. 2 and an expansion bus 262. The specification for the PCI bus 75 is set forth in a specification entitled “PCI Local Bus Specification, Revision 2.2, 1998.” The PCI bus 75 may be coupled to the NIC 20 of FIG. 1, and the I/O controller 264 may receive input from a mouse 266, and a keyboard 268, as well as control operation of a floppy disk drive 270. The I/O hub 252 may also control operations of a CD-ROM drive 258 and a hard disk drive 260.

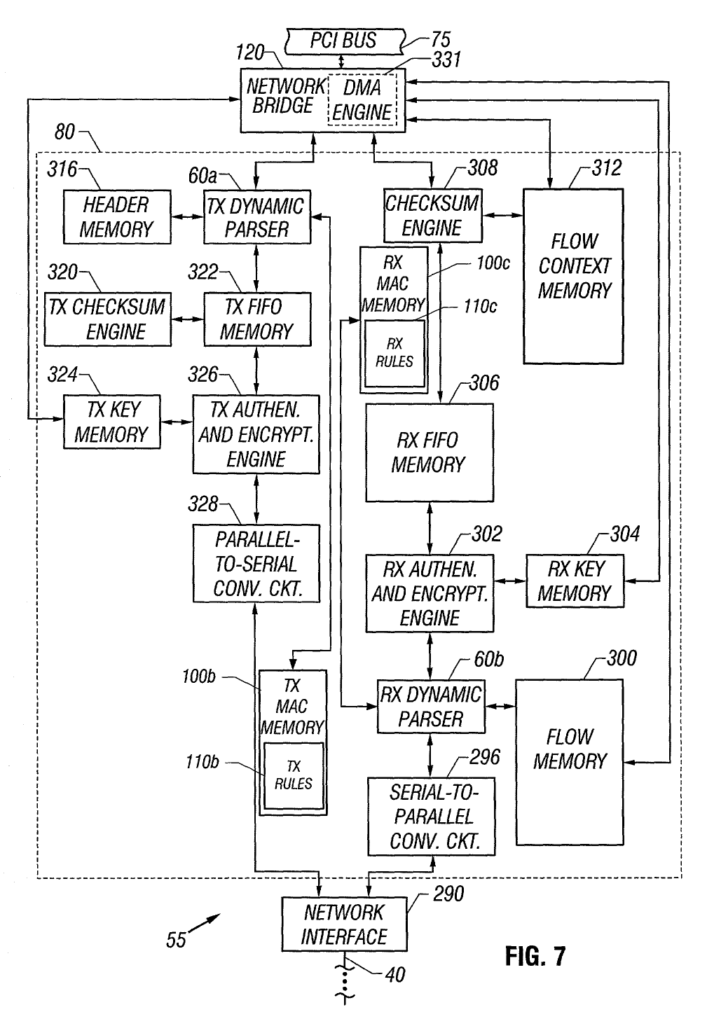

According to one embodiment of the present invention, the Ethernet device 55 of FIG. 7 may include the network adapter 80. In the illustrated embodiment, the network adapter 80 may comprise a transmit (Tx) portion for processing data received from an upper layer, and a receive (Rx) portion for processing Ethernet packets received from the communication medium 40. In the receive (Rx) portion, the network adapter 80 may further include one or more first-in-first-out (FIFO) memories 306 to temporarily store the incoming packets through the communication medium 40. A checksum engine 308 (of the receive (Rx) portion) may be coupled between the FIFO memory 306 and the network bridge 120 for purposes of verifying checksums that are embedded in the packets.

Essentially, the network adapter 80 may interface to the PCI bus 75 via the network bridge 120. The network bridge 120 may include an emulated direct memory access (DMA) engine 331 that is used for the purposes of transferring the data portions of the packets directly into one or more buffers in some embodiments. Moreover, the network adapter 80 may include additional circuitry, such as a serial-to-parallel conversion circuit 296 that may receive a serial stream of bits from a network interface 290 when a packet is received from the communication medium 40, such as a network wire or coaxial cable. In this manner, the conversion circuit 296 packages the bits into bytes and provides these bytes to a receive dynamic parser 60d. The network interface 290 may be coupled to generate and receive signals to/from the network 50 over the communication medium 40 of FIG. 1.

In addition to the receive (Rx) portion, the network adapter 80 may include other hardware circuitry to transmit outing packets to the network 50. In the transmit (Tx) portion, the network adapter 80 may include a transmit dynamic parser 60c that is coupled to the network bridge 120 to receive outgoing packet data from the computer system 230 and form the header on the packets. To accomplish this, in some embodiments, the transmit dynamic parser 60c stores the headers of predetermined flows in a header memory 316. A transmit checksum engine 320 may compute checksums for the IP and network headers of the outgoing packet and incorporate the checksums into the packet.

The transmit (Tx) portion may include a transmit MAC memory 100b, storing a transmit rules 110b. The transmit rules 110b may provide parsing capabilities to the transmit dynamic parser 60c through a loadable set of action-based rules, in one embodiment of the present invention. Likewise, the receive (Rx) portion may include a receive MAC memory 100c, storing a receive rules 110c. The receive rules 110c may provide parsing capabilities to the receive dynamic parser 60d through a loadable set of action-based rules. In some embodiments, each of the transmit and receive dynamic parsers 60c, 60d may include one or more state machines, counter(s) and timer(s), as examples, to perform desired functions for each outgoing and incoming packet, respectively.

The transmit (Tx) portion may further include an authentication and encryption engine 326 that may encrypt and/or authenticate the data of the outgoing packets. In this manner, all packets of a particular flow may be encrypted and/or authenticated via a key that is associated with the flow, and the keys for the different flows may be stored in a key memory 324. The transmit (Tx) portion may also include one or more FIFO memories 322 to synchronize the flow of the packets through the network adapter 80. A parallel-to-serial conversion circuit 328 may be coupled to the FIFO memory 322 to retrieve packets that are ready for transmission for the purposes of serializing the data of the outgoing packets. Once serialized, the circuit 328 may pass the data to the network interface 290 for transmission to the network 50.

Even though packet parsing is done in network hardware, extending the existing parsing capabilities to be dynamically loaded affords numerous advantages in different situations. Advantageously, one embodiment of the present invention may implement many features, such as IPSec, Firewall, VLAN and priority tagging, and header splitting as a means to deploy Zero Copy.

Furthermore, since a dynamic parser does not have to be hardcode, all the parsing rules that may not be useful to some applications or users may be dropped with a relative ease in one embodiment of the present invention. In addition, a need-based selection may be offered by fine-tuning the requirements, saving silicon space. Silicon manufacturing does not have to stall in order to wait for stabilizing standards and silicon validation may be significantly reduced. That is, the silicon code path of a dynamic parser may ideally be validated only once. Once it's validated, no further validation may ideally be needed again when changing the parsing capabilities of the dynamic parser.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
receiving for a host, a data packet in an adapter of an Ethernet device; and
dynamically loading parsing capabilities in the adapter to identify the data packet before transferring the data packet to said host.

2. The method of claim 1, including processing the data packet based on the parsing capabilities to provide media access control layer functionality.

3. The method of claim 2, including:
classifying the data packet by attaching a state to the data packet; and
processing the data packet based on said state.

4. The method of claim 3, including providing parsing and action rules to manipulate the data packet.

5. The method of claim 4, including defining a dynamic parser in firmware.

6. The method of claim 4, including defining a dynamic parser in software.

7. The method of claim 3, including:
determining a packet type of the data packet;
performing a first action on the data packet if the packet type is determined to be associated with a first type; and
performing a second action on the data packet if the packet type is determined to be associated with a second type.

8. The method of claim 7, including:
using a state machine to dynamically parse the data packet based on parsing and action rules;
extracting a portion of data from the data packet based on the state machine; and
enabling the adapter to transfer the data packet from the Ethernet device to a host memory.

9. The method of claim 8, including:
providing a parsing table with at least one table entry to represent the state machine;
setting the state to an initial starting state for the data packet;
using the parsing table to compare a packet offset with a value in the parsing table for the at least one table entry;
determining whether the state is a starting state corresponding to the at least one table entry; and
if so, setting the state as a next state corresponding to the at least one table entry.

10. The method of claim 9, including checking whether the state is a final state, if so, sending the data packet to said host memory.

11. An apparatus comprising:
an adapter to receive a data packet for a host; and
a parser capable of dynamically loading one or more parsing capabilities to identify the data packet.

12. The apparatus of claim 11, further comprising:
a media access controller including a memory storing rules that dynamically loads the one or more parsing capabilities in the parser before transferring the data packet to said host.

13. The apparatus of claim 11, wherein said parser to classify the data packet by attaching a state to the data packet and process the data packet based on said state.

14. The apparatus of claim 13, wherein the rules to selectively provide one or more parsing and action rules to manipulate the data packet.

15. The apparatus of claim 14, further comprising firmware to store the rules defining a dynamic parser.

16. The apparatus of claim 14, further comprising a storage device to store the rules defining a dynamic parser.

17. The apparatus of claim 13, wherein said media access controller to:
determine a packet type of the data packet;
perform a first action on the data packet if the packet type is determined to be associated with a first type; and
perform a second action on the data packet if the packet type is determined to be associated with a second type.

18. The apparatus of claim 11, further comprising an Ethernet device and a host memory to:
use a state machine to dynamically parse the data packet based on parsing and action rules;
extract a portion of data from the data packet based on state machine; and
enable the adapter to transfer the data packet from the Ethernet device to said host memory.

19. The apparatus of claim 18, wherein said state machine to:
provide a parsing table with at least one table entry to represent the state machine;
set the state to an initial starting state for the data packet;
use the parsing table to compare a packet offset with a value in the parsing table for the at least one table entry;
determine whether the state is a starting state corresponding to the at least one table entry; and
if so, set the state as a next state corresponding to the at least one table entry.

20. The apparatus of claim 19, wherein said state machine to check whether the state is a final state, if so, send the data packet to said host memory.

21. An article comprising a medium storing instructions that enable a processor-based system to:
receive for a host, a data packet in an adapter of an Ethernet device; and
dynamically load parsing capabilities in the adapter to identify the data packet before transferring the data packet to said host memory.

22. The article of claim 21 comprising a medium storing instructions that enable said processor-based system to process the data packet based on the parsing capabilities to provide media access control layer functionality.

23. The article of claim 22 comprising a medium storing instructions that enable said processor-based system to:
classify the data packet by attaching a state to the data packet; and
process the data packet based on said state.

24. The article of claim 23 comprising a medium storing instructions that enable said processor-based system to provide parsing and action rules to manipulate the data packet.

25. The article of claim 24 comprising a medium storing instructions that enable said processor-based system to define a dynamic parser in firmware.

26. The article of claim 24 comprising a medium storing instructions that enable said processor-based system to define a dynamic parser in software.

27. The article of claim 23 comprising a medium storing instructions that enable said processor-based system to:
determine a packet type of the data packet;
perform a first action on the data packet if the packet type is determined to be associated with a first type; and
perform a second action on the data packet if the packet type is determined to be associated with a second type.

28. The article of claim 27 comprising a medium storing instructions that enable said processor-based system to:
use a state machine to dynamically parse the data packet based on parsing and action rules;
extract a portion of data from the data packet based on the state machine; and
enable the adapter to transfer the data packet from the Ethernet device to said a host memory.

29. The article of claim 28 comprising a medium storing instructions that enable said processor-based system to:
provide a parsing table with at least one table entry to represent the state machine;
set the state to an initial starting state for the data packet;
use the parsing table to compare a packet offset with a value in the parsing table for the at least one table entry;
determine whether the state is a starting state corresponding to the at least one table entry; and
if so, set the state as a next state corresponding to the at least one table entry.

30. The article of claim 29 comprising a medium storing instructions that enable said processor-based system to check whether the state is a final state, if so, send the data packet to said host memory.
